(19) United States
(12) Patent Application Publication
(10) Pub. No.: US 2024/0247842 A1
(43) Pub. Date: Jul. 25, 2024

(54) MEMBER FOR MAGNETIC COOLING AND AMR BED COMPRISING SAME

(71) Applicant: KOREA INSTITUTE OF MATERIALS SCIENCE, Changwon-si (KR)

(72) Inventors: Kook Chae CHUNG, Changwon-si (KR); Jong Woo KIM, Changwon-si (KR); Ki Hoon KANG, Changwon-si (KR); A Young LEE, Seoul (KR)

(21) Appl. No.: 18/290,362

(22) PCT Filed: Aug. 11, 2022
(86) PCT No.: PCT/KR2022/011971

§ 371 Date: Nov. 13, 2023

(30) Foreign Application Priority Data
Nov. 3, 2021 (KR) 10-2021-0150069

(51) Int. Cl. F25B 21/00

(52) U.S. Cl. CPC F25B 21/00; F25B 2321/0021

(57) ABSTRACT

The present disclosure provides a member for magnetic refrigeration with excellent cooling efficiency, including a tape for magnetic refrigeration having a magnetic refrigeration material charged inside a metal sheath, and a bed for an AMR including the same.

### CROSS REFERENCE TO RELATED APPLICATIONS

This application claims the benefit of priority to Korean Patent Application No. 10-2021-0150069, filed with the Korean Intellectual Property Office on Nov. 3, 2021, the contents of which are incorporated by reference herein in its entirety.

### TECHNICAL FIELD

The present disclosure relates to a member for magnetic refrigeration, and to a bed for an AMR including the same. Specifically, the present disclosure relates to a member for magnetic refrigeration with an excellent cooling efficiency, and to a bed for an AMR including the same.

### BACKGROUND ART

When a magnetic field is applied to a magnetic refrigeration material from the outside, the spins inside the material are aligned in the direction of the applied magnetic field, lowering the magnetic entropy and simultaneously releasing heat to the outside through vibration of the crystal lattice. Meanwhile, when the applied magnetic field is removed, the internal spins change randomly, increasing magnetic entropy and absorbing external heat through vibration of the crystal lattice.

Materials used in magnetic refrigeration technology exhibit the highest magnetic entropy change (ΔS) around T_{c} (transition temperature), at which the transition between paramagnetism and ferromagnetism occurs, and as the temperature is then raised or lowered, the magnetic entropy change decreases. FIG. 1 shows a general ΔS-T curve graph. With this regard, ΔT corresponding to the full width at half maximum (FWHM) of the highest ΔS value is obtained from the ΔS-T curve, and the value of ΔS×ΔT is referred to as a relative cooling power.

Therefore, the optimal operating temperature range of magnetic refrigeration material is around the transition temperature, and ΔS and ΔT of each material are also fixed to some extent. Meanwhile, as a magnetic refrigeration material, LaFeSi-based compounds have a T_{c} in the room temperature range and have the characteristic of being able to vary T_{c} by an additive element. Additionally, it is characterized by that ΔS is about 3 times higher than that of gadolinium. However, ΔT represents a narrow temperature range of about 5 K, so in order to apply LaFeSi-based compounds to a magnetic refrigeration system, T_{c} is controlled and the temperature range (ΔT) is widened through series arrangement.

Active magnetocaloric regenerator (AMR), which is an example of a magnetic refrigeration system in which such magnetic refrigeration material is utilized, the magnetic refrigeration material is charged into a bed, which is a kind of structure of shape. Then, heat exchange occurs as the heat exchange fluid periodically flows through the inside of the bed charged with the refrigerant. The LaFeSi-based compound has the property of being brittle and is difficult to process in a bulk form after their alloy formation, so it is crushed into powder form and then used as the powder itself, or used in the form of a molded body formed by being mixed with a binder like polymer or metal, or it has been used in a bulk form formed by molding and heat-treating LaFeSi-based compound powder prepared by adding an element such as Co.

However, when a magnetic refrigeration material is charged in powder form, the high surface area of the powder is advantageous for heat exchange, but it acts as a high resistance to the flow of fluid and the loss of the powder is serious. Additionally, there is a problem of corrosion of magnetic refrigeration materials by fluids such as water. Additionally, in the case of the bulk molded body formed by being mixed with polymer or metal, it is mainly manufactured and charged in a plate shape to facilitate the laminar flow of the heat exchange fluid, but there is a risk that the overall magnetic refrigeration efficiency may be reduced due to the weight and volume occupied by the polymer and metal for maintaining the shape of the molded body, and it is difficult to maintain the plate-shaped molded body by molding it to a small thickness of 1 mm or less. Additionally, in the case of the bulk form formed by adding an element such as Co, several problems are caused as follows: It can be processed into various shapes, but cutting processing must be performed to achieve such shapes; the consumption due to the cutting processing is high; and because very narrow flow channels are formed to increase the surface area, it is difficult to maintain the shape.

To solve above-described problems, there is a need for another alternative in the form of introducing a magnetic refrigeration material into the bed.

### Disclosure

### Technical Problem

The technical object to be achieved by the present disclosure is to provide a member for magnetic refrigeration with excellent cooling efficiency resulting from a wide temperature range, and a bed for an AMR including the same.

However, the objectives to be achieved by the present disclosure are not limited to the above-mentioned one, and other unmentioned objectives will be clearly understood by those skilled in the art from the following description.

### Technical Solution

According to an aspect of the present disclosure, there is provided a member for magnetic refrigeration including a tape for magnetic refrigeration having a heat dissipation sheath, and a magnetic refrigeration material charged inside the heat dissipation sheath, wherein a spacer is provided on the surface of the tape for magnetic refrigeration, and the tape for magnetic refrigeration has a concentric multi-layer structure.

According to an aspect of the present disclosure, there is provided a bed for an active magnetocaloric regenerator (AMR) including the member for magnetic refrigeration.

### Advantageous Effects

The member for magnetic refrigeration according to an embodiment of the present disclosure can solve problems such as loss of magnetic refrigeration material, corrosion due to heat exchange fluid, and pressure loss.

The member for magnetic refrigeration according to an embodiment of the present disclosure can have the wide temperature span to adjust the cooling temperature over a wide range.

The member for magnetic refrigeration according to an embodiment of the present disclosure can be manufactured at low cost.

The bed for an AMR according to an embodiment of the present disclosure can ensure laminar flow by reducing the resistance of the heat exchange fluid.

The bed for an AMR according to an embodiment of the present disclosure can freely control and secure the flow path volume, thereby enabling the smooth heat exchange between the magnetic refrigeration material and the heat exchange fluid.

The effects of the present disclosure are not limited to the aforementioned ones, but other unmentioned effects thereof will be clearly understood by those skilled in the art from the present specification.

### BRIEF DESCRIPTION OF DRAWINGS

FIG. 1 shows a general ΔS-T curve graph.

FIGS. 2A and 2B show schematic cross-sections of a tape for magnetic refrigeration included in a member for magnetic refrigeration according to an embodiment of the present disclosure.

FIG. 3 shows examples of the shape of a member for magnetic refrigeration, the forms of spacers, and the side cross-sectional shapes of a tape according to an embodiment of the present disclosure.

FIGS. 4A and 4B show schematic and cross-sectional views of a member for magnetic refrigeration according to an embodiment of the present disclosure.

FIGS. 5A and 5B show schematic views of a bed for an AMR according to an embodiment of the present disclosure.

FIG. 6A shows the M-T curve of La (Fe, Si)₁₃—H powder of Preparation Example 1.

FIG. 6B shows the M-T curve of a member for magnetic refrigeration of Example 1.

FIG. 6C shows the M-T curve of a member for magnetic refrigeration of Example 2.

FIG. 6D shows the M-T curve of a member for magnetic refrigeration of Example 3.

FIG. 7A shows the M-H curve of La (Fe, Si)₁₃—H powder of Preparation Example 1.

FIG. 7B shows the M-H curve of a member for magnetic refrigeration of Example 1.

FIG. 7C shows the M-H curve of a member for magnetic refrigeration of Example 2.

FIG. 7D shows the M-H curve of a member for magnetic refrigeration of Example 3.

FIG. 8A shows the ΔS-T graph of La (Fe, Si)₁₃—H powder of Preparation Example 1.

FIG. 8B shows the ΔS-T graph of a member for magnetic refrigeration of Example 1.

FIG. 8C shows the ΔS-T graph of a member for magnetic refrigeration of Example 2.

FIG. 8D shows the ΔS-T graph of a member for magnetic refrigeration of Example 3.

FIG. 9A shows the graph of the maximum value of the absolute value of the entropy change (|ΔS|) of La (Fe, Si)₁₃—H powder of Preparation Example 1, a member for magnetic refrigeration of Example 1, a member for magnetic refrigeration of Example 2, and a member for magnetic refrigeration of Example 3.

FIG. 9B shows the graph of ΔT corresponding to the FWHM of La (Fe, Si)₁₃—H powder of Preparation Example 1, a member for magnetic refrigeration of Example 1, a member for magnetic refrigeration of Example 2, and a member for magnetic refrigeration of Example 3.

FIG. 9C shows the magnetic field dependence of the relative cooling efficiency calculated by multiplying ΔT corresponding to the FWHM with the maximum value of the absolute value of the entropy change (|ΔS|) of La (Fe, Si)₁₃—H powder of Preparation Example 1, a member for magnetic refrigeration of Example 1, a member for magnetic refrigeration of Example 2, and a member for magnetic refrigeration of Example 3.

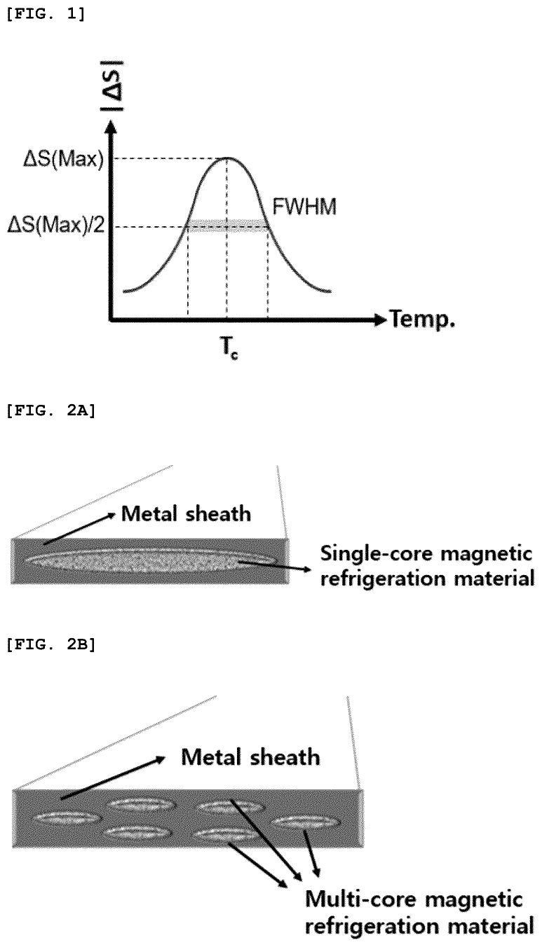

### BEST MODE FOR PRACTICING DISCLOSURE

Throughout the specification of the present application, when a part “includes” or “comprises” a component, it means not that the part excludes other component, but instead that the part may further include other component unless expressly stated to the contrary.

Throughout the specification of the present application, when a member is described as being located “on” another member, this includes not only a case in which the member is in contact with the other member but also a case in which another member exists between the two members.

Throughout this specification, the unit “parts by weight” may mean a ratio of weight between the respective components.

Throughout this specification, “A and/or B” refers to “A and B, or A or B.”

Hereinafter, the present disclosure will be described in more detail.

According to an embodiment of the present disclosure, there is provided a member for magnetic refrigeration including a tape for magnetic refrigeration having a heat dissipation sheath, and a magnetic refrigeration material charged inside the heat dissipation sheath, wherein a spacer is provided on the surface of the tape for magnetic refrigeration, and the tape for magnetic refrigeration has a concentric multi-layer structure.

The member for magnetic refrigeration according to an embodiment of the present disclosure can solve problems such as loss of magnetic refrigeration material, corrosion due to heat exchange fluid, and pressure loss, and can have a wide temperature span to adjust the cooling temperature over a wide range, and can be manufactured at low cost.

Hereinafter, the present disclosure will be described in more detail.

The member for magnetic refrigeration according to an embodiment of the present disclosure includes a tape for magnetic refrigeration which has a heat dissipation sheath and a magnetic refrigeration material charged inside the heat dissipation sheath. The heat dissipation sheath may play a protecting role, such as, by preventing loss of the magnetic refrigeration material therein, and may be made of a material with excellent thermal conductivity which performs the function of dissipating heat. The magnetic refrigeration material may produce a cooling effect by absorbing energy by applying and removing a magnetic field.

According to an embodiment of the present disclosure, the heat dissipation sheath may include one or more kinds selected from the group consisting of metal, polymer, and inorganic filler. The heat dissipation sheath is preferably made of a material with excellent thermal conductivity as a material advantageous for heat exchange, which may be selected based on the magnetic refrigeration system and magnetic refrigeration material to be applied.

According to an embodiment of the present disclosure, the metal may include one or more kinds selected from the group consisting of Cu, Cu-based alloy, Ti, Ti-based alloy, Ni, Ni-based alloy, Ag, Fe, Nb, stainless steel, Gd, and Gd-based alloy; the polymer may include one or more kinds selected from the group consisting of epoxy resin, polypropylene, high-density polyethylene, polyvinyl alcohol, silicone elastomer, polyimide, polystyrene, and polyvinylidene fluoride; and the high thermal conductive filler may include one or more kinds selected from the group consisting of aluminum nitride, boron nitride, magnesia, alumina, graphite, graphene, silicon carbide, diamond, aluminum, gold, copper, lead, stainless steel, and silver. For example, the heat dissipation sheath may be a metal sheath, or may be a sheath including the polymer and the high thermal conductive filler.

Additionally, according to an embodiment of the present disclosure, the heat dissipation sheath may have a multi-layer structure as needed. Specifically, the heat dissipation sheath may include a metal sheath; and a heat dissipation layer provided on the outside of the metal sheath and including a polymer and a high thermal conductive filler.

According to an embodiment of the present disclosure, the magnetic refrigeration material may include one or more kinds selected from the group consisting of a Gd-based compound, a La (Fe, Si)₁₃-based compound, a La (Fe, Si)₁₃H-based compound, a La (Fe, Al)₁₃-based compound, a (Mn, Fe)₂ (P, Si)-based compound, a Mn-based Heusler alloy, a Ln-based magnesite, and a FeRh-based compound.

In other words, the magnetic refrigeration material may include a material of a single composition selected from the group consisting of a Gd-based compound, a La (Fe, Si)₁₃-based compound, a La (Fe, Si)₁₃H-based compound, a La (Fe, Al)₁₃-based compound, a (Mn, Fe)₂ (P, Si)-based compound, a Mn-based Heusler alloy, a Ln-based magnesite, and a FeRh-based compound, may use a material with a mixed composition including one or more kinds selected from the group consisting of a Gd-based compound, a La (Fe, Si)₁₃-based compound, a La (Fe, Si)₁₃H-based compound, a La (Fe, Al)₁₃-based compound, a (Mn, Fe)₂ (P, Si)-based compound, a Mn-based compound Heusler alloy, a Ln-based magnesite, and a FeRh-based compound, or may be a mixture of two or more materials with different compositions due to the different content of ingredients in a material selected from the group consisting of a Gd-based compound, a La (Fe, Si)₁₃-based compound, a La (Fe, Si)₁₃H-based compound, a La (Fe, Al)₁₃-based compound, a (Mn, Fe)₂ (P, Si)-based compound, a Mn-based Heusler alloy, a Ln-based magnesite, and a FeRh-based compound. When using two or more mixed magnetic refrigeration materials rather than using a material of a single composition, AT can be further expanded as magnetic refrigeration materials with different transition temperatures are mixed. Therefore, the member for magnetic refrigeration of the present disclosure may include two or more kinds of magnetic refrigeration materials with different compositions.

In the case of an AMR to which the member for magnetic refrigeration according to an embodiment of the present disclosure can be applied, cooling is performed through heat exchange between the heat exchange fluid and the member for magnetic refrigeration, and so, in some cases, it may be necessary to adjust the temperature at the point where the heat exchange fluid enters to be different from the temperature at the point where the heat exchange fluid discharges.

Therefore, according to an embodiment of the present disclosure, the member for magnetic refrigeration may include a plurality of the tapes for magnetic refrigeration, each of which is charged with the magnetic refrigeration material having a different transition temperature (T_{c}) along more than one section in the axial direction of the member for magnetic refrigeration. Specifically, the member for magnetic refrigeration may be divided into the first zone, second zone, third zone, . . . and nth zone in its axial direction, each of which may include a tape for magnetic refrigeration charged with a corresponding first magnetic refrigeration material, a second magnetic refrigeration material, a third magnetic refrigeration material, . . . or an nth magnetic refrigeration material with different transition temperature. The sections may be divided into the same length or may be divided into different lengths. The number and length of the sections may be adjusted depending on the type of heat exchange fluid, the kind and characteristics of refrigeration system, and the like.

According to an embodiment of the present disclosure, additionally, the tape for magnetic refrigeration may be charged with the magnetic refrigeration material whose transition temperature (T_{c}) continuously varies in the axial direction of the member for magnetic refrigeration. That is, the magnetic refrigeration material may be charged so that the transition temperature has a gradient along the length of the tape for magnetic refrigeration without separate division in the width or length direction of the tape for magnetic refrigeration, and the member for magnetic refrigeration may be constructed from such tape for magnetic refrigeration. For example, when the magnetic refrigeration material is a La (Fe, Si)₁₃-based compound, the magnetic refrigeration material may be charged in a composition in which the content of an additive element increases or decreases in the length direction of the tape so that the transition temperature has a gradient along the length of the tape.

Additionally, when the member for magnetic refrigeration according to an embodiment of the present disclosure is a coil formed by winding the tape for magnetic refrigeration, the member for magnetic refrigeration may include a plurality of the tapes for magnetic refrigeration, each of which is charged with the magnetic refrigeration material having a different transition temperature (T_{c}) along more than one section in the length direction of the tape for magnetic refrigeration. Specifically, the member for magnetic refrigeration may be divided into the first zone, second zone, third zone, . . . and nth zone in the length direction of the tape for magnetic refrigeration, each of which may include a tape for magnetic refrigeration charged with a corresponding first magnetic refrigeration material, a second magnetic refrigeration material, a third magnetic refrigeration material, . . . or an nth magnetic refrigeration material with different transition temperature. The sections may be divided into the same length or may be divided into different lengths. The number and length of the sections may be adjusted depending on the type of heat exchange fluid, the kind and characteristics of refrigeration system, and the like.

According to an embodiment of the present disclosure, additionally, the tape for magnetic refrigeration may be charged with the magnetic refrigeration material whose transition temperature (T_{c}) continuously varies in the length direction of the tape for magnetic refrigeration. That is, the magnetic refrigeration material may be charged so that the transition temperature has a gradient along the length of the tape for magnetic refrigeration without separate division in the length direction of the tape for magnetic refrigeration. For example, when the magnetic refrigeration material is a La (Fe, Si)₁₃-based compound, the magnetic refrigeration material may be charged in a composition in which the content of an additive element increases or decreases in the length direction of the tape so that the transition temperature has a gradient along the length of the tape.

According to an embodiment of the present disclosure, additionally, in the case where magnetic refrigeration materials with different transition temperatures are charged in the length direction of the tape for magnetic refrigeration, when the coil in which the tape for magnetic refrigeration is wound is provided into the bed of the refrigeration system, the winding axis corresponds to the length direction of the bed. At this time, in the cross section of the coil, the central portion where the heat exchange fluid flow rate is relatively high and the peripheral portion where the heat exchange fluid flow rate is relatively slow may be in contact with the tapes for magnetic refrigeration made of different magnetic refrigeration materials.

According to an embodiment of the present disclosure, the member for magnetic refrigeration may include a plurality of the tapes for magnetic refrigeration, each of which is charged with the magnetic refrigeration material having a different transition temperature (T_{c}) along more than one section in the length direction of the coil. Specifically, the member for magnetic refrigeration may be divided into the first zone, second zone, third zone, . . . and nth zone in the length direction of the coil, each of which may include a tape for magnetic refrigeration charged with a corresponding first magnetic refrigeration material, a second magnetic refrigeration material, a third magnetic refrigeration material, . . . or an nth magnetic refrigeration material with different transition temperature. The sections may be divided into the same length or may be divided into different lengths. The number and length of the sections may be adjusted depending on the type of heat exchange fluid, the kind and characteristics of refrigeration system, and the like.

According to an embodiment of the present disclosure, the tape for magnetic refrigeration may be charged with the magnetic refrigeration material whose transition temperature (T_{c}) continuously varies in the length direction of the coil. That is, the magnetic refrigeration material may be charged so that the transition temperature has a gradient along the length of the coil without separate division in the length direction of the coil. For example, when the magnetic refrigeration material is a La (Fe, Si)₁₃-based compound, the magnetic refrigeration material may be charged in a composition in which the content of an additive element increases or decreases in the length direction of the coil so that the transition temperature has a gradient along the length of the coil.

According to an embodiment of the present disclosure, the magnetic refrigeration material may be in the form of powder to be charged.

According to an embodiment of the present disclosure, the magnetic refrigeration material may be included in the tape for magnetic refrigeration in a single-core structure or multi-core structure. That is, the cross section of the tape for magnetic refrigeration may include the cross section of the metal sheath; and one or more cross-sections of magnetic refrigeration material contained within the metal sheath. FIGS. 2A and 2B show schematic cross-sections of a tape for magnetic refrigeration included in a member for magnetic refrigeration according to an embodiment of the present disclosure. Referring to FIGS. 2A and 2B, there is one space inside the metal sheath and a magnetic refrigeration material is charged therein, that is, it may be a single-core structure (FIG. 2A), or there are several spaces inside the metal sheath. and each may have a magnetic refrigeration material charged therein, that is, a multi-core structure (FIG. 2B).

According to an embodiment of the present disclosure, when the magnetic refrigeration material is included in the tape for magnetic refrigeration in the multi-core structure, the magnetic refrigeration material in each core may be independently different from or the same as the magnetic refrigeration material in each different core. Specifically, when the magnetic refrigeration material is charged into each of several spaces inside the metal sheath, the magnetic refrigeration material charged into each space may be different from or the same as the magnetic refrigeration material charged into each different space, and may be different from or the same as the magnetic refrigeration material charged into each different space in particular in terms of the transition temperature. In the case of the tape for magnetic refrigeration with the multi-core structure, when the magnetic refrigeration material of each core is different from the magnetic refrigeration material of each different core, different types of cooling gradients can be implemented according to the use or purpose of the refrigeration system to which the tape for magnetic refrigeration is applied.

According to an embodiment of the present disclosure, when the magnetic refrigeration material is included in the tape for magnetic refrigeration in the multi-core structure, even if the amount of the magnetic refrigeration material included in the tape for magnetic refrigeration is the same, the total contact area of the respective cores of the multi-core structure with the metal sheath increases, which in turn leads to an increase in the efficiency of heat transfer, thereby enhancing the magnetic refrigeration effect.

According to an embodiment of the present disclosure, the tape for magnetic refrigeration may have a thickness of 0.01 mm to 1 mm, 0.01 mm to 0.1 mm, or 0.01 mm to 0.05 mm. When the member for magnetic refrigeration is made of the tape for magnetic refrigeration having the thickness within the above range, its refrigeration efficiency may be excellent.

According to an embodiment of the present disclosure, the width of the tape for magnetic refrigeration may be adjusted according to the purpose. For example, by making the length of the bed of the refrigeration system equal to the width of the tape for magnetic refrigeration, the width may be adjusted so that one member for magnetic refrigeration is charged into the bed of the refrigeration system, or by considering the length of the bed of the refrigeration system, the width may be adjusted so that several members for magnetic refrigeration can be charged into the bed of the refrigeration system.

According to an embodiment of the present disclosure, the cross-sectional shape of the tape for magnetic refrigeration may be oval or rectangular. That is, the tape for magnetic refrigeration may have a strap shape whose thickness is smaller than its width. There is no particular restriction on the shape of the tape for magnetic refrigeration, but the shape of the tape for magnetic refrigeration may be adjusted based on the shape of the member for magnetic refrigeration for application to a refrigeration system in the relevant technical field.

According to an embodiment of the present disclosure, in the cross section of the tape for magnetic refrigeration, a ratio of the area occupied by the magnetic refrigeration material may be 10% to 90% or 50% to 90%. The ratio may be selected based on the strength and integrity of the sheath, and when the ratio within the above range in the cross-sectional area is selected, the heat conduction efficiency of the metal sheath can be excellent while addressing problems such as loss of magnetic refrigeration material during operation of the refrigeration system.

According to an embodiment of the present disclosure, a spacer is provided on the surface of the tape for magnetic refrigeration. When the tape for magnetic refrigeration is wound, the spacer provided on the surface of the tape for magnetic refrigeration may form a gap by preventing the respective surfaces of the tape for magnetic refrigeration from contacting each other, and may be controlled to secure the above gap as a heat exchange fluid flow channel, so that, as a result, a laminar flow of the heat exchange fluid with low resistance can be obtained. According to an embodiment of the present disclosure, the spacer may have a height of 0.01 mm to 1 mm. The height of the spacer may be adjusted based on the thickness of the tape for magnetic refrigeration, the entire size of the member for magnetic refrigeration, the standard of the bed of the refrigeration system to which the present disclosure is applicable, the dynamical properties of the heat exchange fluid, or the like.

According to an embodiment of the present disclosure, the spacer may be in the form of a circular protrusion, a polygonal protrusion, a curved bar, or a polygonal bar. When the tape for magnetic refrigeration is wound, the spacer serves to keep the respective surfaces of the tape for magnetic refrigeration spaced apart from each other so that the respective surfaces do not directly contact each other, and the shape of the spacer may be selected based on the thickness of the tape for magnetic refrigeration, the entire size of the member for magnetic refrigeration, the standard of the bed of the refrigeration system to which the present disclosure is applicable, the dynamical properties of the heat exchange fluid, or the like.

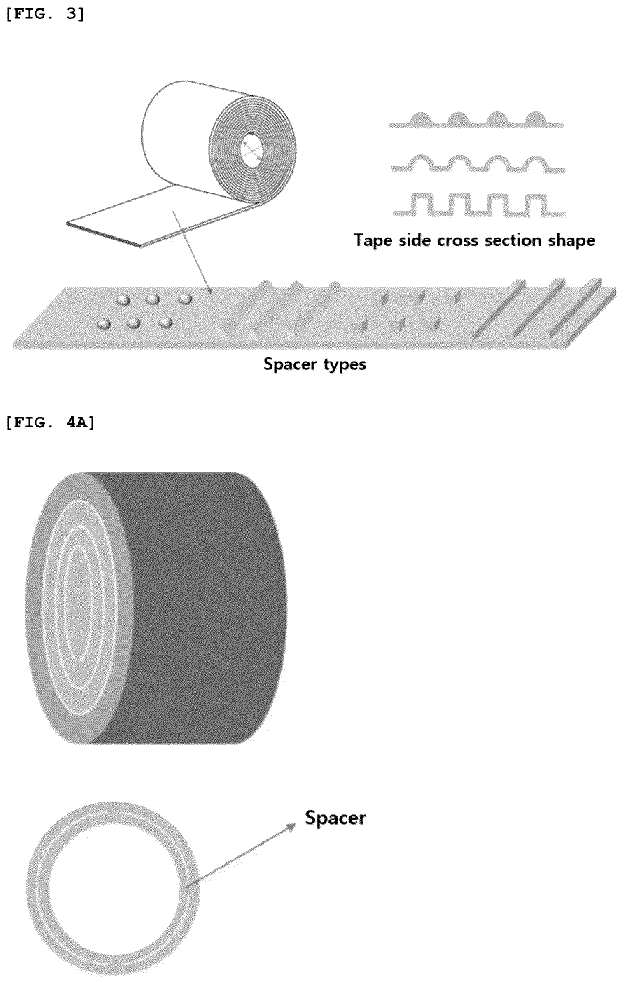

FIG. 3 shows examples of the shape of a member for magnetic refrigeration, the forms of spacers, and the side cross-sectional shapes of a tape according to an embodiment of the present disclosure.

Referring to FIG. 3, a schematic shape can be seen when the tape for magnetic refrigeration is wound to form the member for magnetic refrigeration, and spacers of various shapes can be formed on the surface of the tape for magnetic refrigeration, examples of which are shown.

Specifically, if explained sequentially from left to right, the spacer may be in the form of a circular protrusion. That is, it may be a curved protrusion when viewed from the side, and the distance from the highest part to the surface of the magnetic tape may be the height of the spacer. The spacers in the form of circular protrusions may be provided in plural numbers and spaced apart from each other at a predetermined interval.

Next, the spacer may be in the form of a curved bar. That is, the spacer may be a bar-shaped protrusion which extends from one side to the other side in the width direction of the tape, and may have a curved shape when viewed from the side of the tape, and the height of the spacer may be the distance from the highest part to the surface of the magnetic tape. The spacers in the form of circular protrusions may be provided in plural numbers and spaced apart from each other at a predetermined interval.

Next, the spacer may be in the form of a polygonal protrusion. That is, it may be a polygonal protrusion when viewed from the side, and the distance from the highest part to the surface of the magnetic tape may be the height of the spacer. The spacers in the form of polygonal protrusion may be provided in plural numbers and spaced apart from each other at a predetermined interval.

Next, the spacer may be in the form of a polygonal bar. That is, the spacer may be a bar-shaped protrusion which extends from one side to the other side in the width direction of the tape, and may have a polygonal shape when viewed from the side of the tape, and the height of the spacer may be the distance from the highest part to the surface of the magnetic tape. The spacers in the form of polygonal bar may be provided in plural numbers and spaced apart from each other at a predetermined interval.

According to an embodiment of the present disclosure, the spacer may be provided by attaching a spacer member to the surface of the tape for magnetic refrigeration, or may be provided by deforming the tape for magnetic refrigeration into a protruding shape through a process such as pressing process. Specifically, referring to the upper right corner of FIG. 3, when the spacer member is attached to the surface of the tape for magnetic refrigeration and viewed from the side, the spacer may have a cross-section in which the inside of the spacer is filled, and alternatively, the spacer is formed by bending the tape for magnetic refrigeration through a process such as a pressing process to provide a protruding shape, and thus, when viewed from the side, the spacer may have a cross-section in which the inside of the spacer is not filled.

According to an embodiment of the present disclosure, one or more spacers may be provided on part or all of the surface of the tape for magnetic refrigeration. Specifically, several spacers may be provided at regular intervals on the surface of the tape for magnetic refrigeration, and, may be provided at irregular intervals, taking into consideration that in the member for magnetic refrigeration, the number of layers of the multi-layer structure of the tape for magnetic refrigeration is adjusted or that the diameter of the coil-shaped member for magnetic refrigeration varies depending on winding.

According to an embodiment of the present disclosure, the member for magnetic refrigeration includes the tape for magnetic refrigeration in a concentric multi-layer structure. That is, the tape for magnetic refrigeration may be cut into a plurality of fragments, which are manufactured into structures of different sizes, and then these structures may be combined to form a member for magnetic refrigeration including the tape for magnetic refrigeration in a multi-layer structure.

According to an embodiment of the present disclosure, the concentric multi-layer structure may have a concentric circle shape, a concentric ellipse shape, a concentric polygon shape, or a spiral shape in the cross section of the member for magnetic refrigeration. Specifically, the cross section of the member for magnetic refrigeration may be in the form of circles of different diameters with their centers at one point, or may be in the form of regular polygons of different side lengths with their centers at one point, or may be in the form of polygons of different corresponding side lengths with their centers at one point, or may be in the form of spirals of regular or irregular line spacing based on one center.

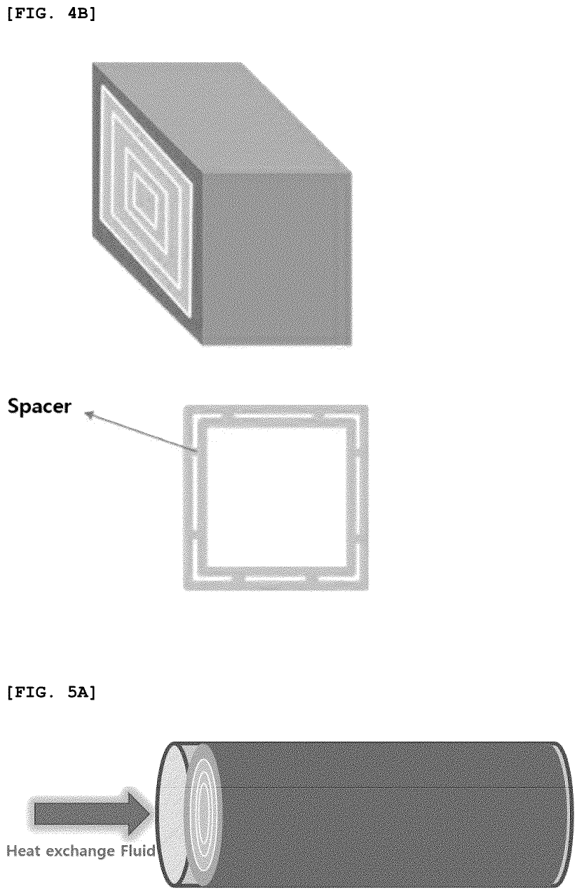

FIGS. 4A and 4B show schematic and cross-sectional views of a member for magnetic refrigeration according to an embodiment of the present disclosure.

Referring to FIGS. 4A and 4B, the member for magnetic refrigeration may include the tape for magnetic refrigeration in a multi-layer structure in the form of a concentric circle (FIG. 4A) or in the form of a concentric polygon (FIG. 4B). Specifically, referring to FIG. 4A, the tape for magnetic refrigeration may be cut into fragments of different lengths, each of which may be then attached at opposite ends to form a circular ring shape, and these fragmentary tapes having ring shapes of different diameters may be nested with their centers at one point to form a member for magnetic refrigeration, and referring to FIG. 4B, the tape for magnetic refrigeration may be cut into fragments of different lengths, each of which may be then formed in a polygonal ring shape, for example, a quadrangular ring shape as shown in the drawing, and these fragmentary tapes having ring shapes of different sizes may be nested with their centers at one point to form a member for magnetic refrigeration. Alternatively, the member for magnetic refrigeration may be formed by bending the tape, or may be manufactured by cutting the tape into tape fragments and attaching them.

According to an embodiment of the present disclosure, the member for magnetic refrigeration may include the tape for magnetic refrigeration in a spiral structure on the cross section of the member for magnetic refrigeration. Specifically, the member for magnetic refrigeration may be a coil formed by winding the tape for magnetic refrigeration.

According to an embodiment of the present disclosure, the member for magnetic refrigeration may be manufactured through a process including manufacturing a tape for magnetic refrigeration including a heat dissipation sheath and a magnetic refrigeration material charged inside the heat dissipation sheath; and manufacturing a member for magnetic refrigeration by processing the tape for magnetic refrigeration.

According to an embodiment of the present disclosure, the method of manufacturing a tape for magnetic refrigeration may include using a method well known in the art, for example, using the PIT (Powder In Tube) method as described below.

The tape for magnetic refrigeration according to an embodiment of the present disclosure may be manufactured by a method including: preparing a heat dissipation sheath; charging a magnetic refrigeration material into the internal space of the heat dissipation sheath; processing the heat dissipation sheath charged with the magnetic refrigeration material to control its diameter and increase its length; and forming a spacer.

According to an embodiment of the present disclosure, the heat dissipation sheath may be manufactured directly, but commercially available one may also be purchased and used as the heat dissipation sheath.

According to an embodiment of the present disclosure, the heat dissipation sheath may be manufactured by a known method. For example, it may be manufactured by melting metal particles using an induction heating method, pouring the melt metal into a mold to manufacture it into a rod shape, and forming a space inside the rod through processing such as drilling or electric discharge machining.

According to an embodiment of the present disclosure, the magnetic refrigeration material may be charged into the internal space of the heat dissipation sheath. At this time, the magnetic refrigeration material may be in powder form. Additionally, when charging the magnetic refrigeration material, as described above, a different composition or type of magnetic refrigeration material may be charged based on the shape of the member for magnetic refrigeration to be manufactured.

According to an embodiment of the present disclosure, the magnetic refrigeration material may be used by purchasing commercially available one, or by being manufactured directly. For example, a La (Fe, Si)₁₃—H compound may be manufactured as a magnetic refrigeration material as follows: materials such as La, Fe, Si, and Mn dopant for controlling the transition temperature may be mixed at the desired composition ratio, and this mixture may be melted and bulked by an arc melting method, and then the bulk may conditions, for example, at a be heat-treated under vacuum temperature of 900° C. to 1200° C. for 3 to 10 days, and the thus heat-treated bulk may be pulverized to prepare a powder, and then the powder may be heat-treated in a hydrogen atmosphere, for example, at a temperature of about 150° C. to 500° C. for about 1 hour to 10 hours.

According to an embodiment of the present disclosure, the metal sheath charged with the magnetic refrigeration material may be processed to control its diameter and increase its length. In the case of the metal sheath charged with the magnetic refrigeration material, the length may need to be extended and the diameter may need to be adjusted based on the bed length of the refrigeration system to which the present disclosure is applicable, the target cooling temperature, or the like, and so it may be processed through a process such as drawing, rolling, swaging, or the like.

According to an embodiment of the present disclosure, the metal sheath may be processed into a tape shape through the above processing step including a flat rolling process. Specifically, in the above-described processing step, the length of the metal sheath charged with the magnetic refrigeration material may be increased and the diameter thereof may be reduced through the rolling, and the flat rolling process may be further performed to process the resulting metal sheath into a tape shape for easy winding. Through the flat rolling process, it may be processed into a tape shape, for example, with an elliptical or rectangular cross-sectional shape.

According to an embodiment of the present disclosure, next, the spacer may be formed. Specifically, the spacer may be formed through a pressing process on the surface of the tape for magnetic refrigeration formed after the above-described processing step. Meanwhile, the tape for magnetic refrigeration according to an embodiment of the present disclosure may be manufactured by a method including: preparing a first metal sheath and a second metal sheath having a smaller diameter than that of the first metal sheath; charging magnetic refrigeration material into the internal space of the second metal sheath; inserting one or more second metal sheaths into the first metal sheath; and processing the first metal sheath into which the second metal sheath has been inserted to control its diameter and increase its length. Specifically, the above-described process may be one introduced to manufacture the tape for magnetic refrigeration having a multi-core structure, and the specific process may be as described above.

According to one embodiment of the present disclosure, details regarding the metal sheath and magnetic refrigeration material in the manufacturing process may be the same as those described above for the magnetic refrigeration core.

The tape for magnetic refrigeration according to an embodiment of the present disclosure may be manufactured by a method including: preparing a plurality of metal sheaths; charging magnetic refrigeration material into each of the internal spaces of the plurality of metal sheaths; processing the plurality of metal sheaths charged with the magnetic refrigeration material to control their diameters and increase their lengths; combining the processed plurality of metal sheaths charged with the magnetic refrigeration material and forming them into a tape shape; and forming a spacer, and alternatively, preparing a plurality of first metal sheaths and a plurality of second metal sheaths each of which has a smaller diameter than that of the first metal sheath; charging magnetic refrigeration material into each of the internal spaces of the plurality of second metal sheaths; inserting one or more second metal sheaths into the plurality of first metal sheaths; and combining the plurality of first metal sheaths into which the second metal sheath has been inserted and forming them into a tape shape; and forming a spacer.

According to an embodiment of the present disclosure, the plurality of metal sheaths charged with magnetic refrigeration material may be combined to constitute a tape shape, and specifically, the tape for magnetic refrigeration may be formed through a process that includes twisting the plurality of metal sheaths charged with the magnetic refrigeration material. The tape for magnetic refrigeration with a multi-core structure can be manufactured through the above-described process, and specifically, the tape for magnetic refrigeration including the magnetic refrigeration material may be manufactured in a multi-core structure through the above-described method.

According to an embodiment of the present disclosure, the member for magnetic refrigeration may be manufactured by processing the tape for magnetic refrigeration. Specifically, the member for magnetic refrigeration may be manufactured by a process including: cutting the tape for magnetic refrigeration to obtain a plurality of tape fragments for magnetic refrigeration having different lengths; connecting the opposite ends of each of the plurality of tape fragments for magnetic refrigeration having different lengths to form a circular, oval or polygonal ring; and forming a member for magnetic refrigeration by nesting a plurality of the ring-shaped tapes for magnetic refrigeration.

Additionally, according to an embodiment of the present disclosure, the member for magnetic refrigeration may be manufactured by a process including: forming a core part using the tape for magnetic refrigeration; and forming a multi-layer structure by repeating a step of wrapping a tape for magnetic refrigeration on the outer surface of the core part. Specifically, the core part which becomes the axle of the member for magnetic refrigeration may be formed using the tape for magnetic refrigeration, and an additional layer may be formed layer by layer on the outside of the core part to form the member for magnetic refrigeration. The number of layers of the multi-layer structure may be adjusted based on the thickness of the tape for magnetic refrigeration and the standards of the refrigeration system in which the member for magnetic refrigeration is to be utilized.

According to an embodiment of the present disclosure, a bed for an active magnetocaloric regenerator (AMR) including the member for magnetic refrigeration is provided.

The bed for an AMR according to an embodiment of the present disclosure can ensure laminar flow by reducing the resistance of the heat exchange fluid, and can also freely control and secure the flow path volume of the heat exchange fluid, thereby enabling the smooth heat exchange between the magnetic refrigeration material and the heat exchange fluid.

The bed for an AMR according to an embodiment of the present disclosure may include the member for magnetic refrigeration, and specifically may include one or more members for magnetic refrigeration.

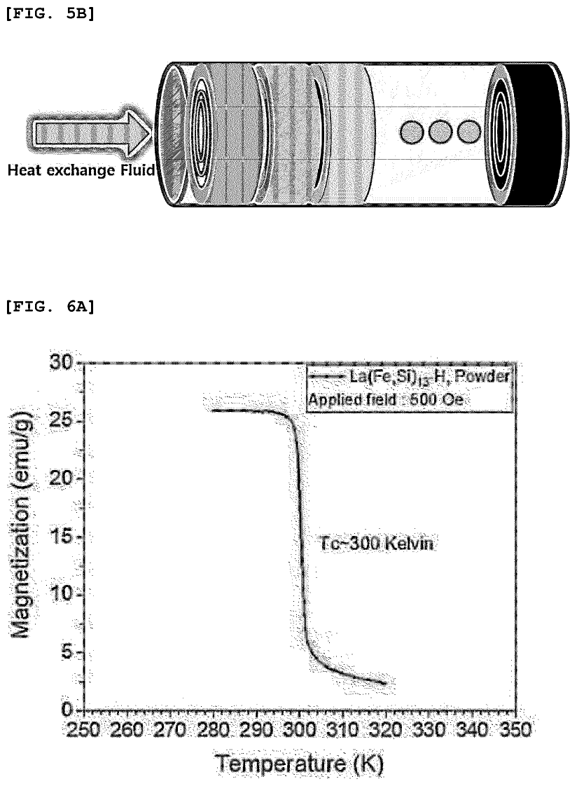

FIGS. 5A and 5B show schematic diagrams of a bed for an AMR according to an embodiment of the present disclosure. Specifically, FIG. 5A shows an embodiment in which one member for magnetic refrigeration is introduced, and FIG. 5B shows an embodiment in which several members for magnetic refrigeration are introduced. Referring to FIGS. 5A and 5B, when the length of the member for magnetic refrigeration is the same as the length of the bed for an AMR, the bed for an AMR may include one member for magnetic refrigeration. Additionally, when the length of the member for magnetic refrigeration is shorter than the length of the bed for an AMR, several members for magnetic refrigeration may be included in series, such that they may be in direct contact to each other or spaced apart from each other at a predetermined distance. In the case of including the several members for magnetic refrigeration, the magnetic refrigeration material included in each of the members for magnetic refrigeration may be independently different from or the same as each other as described above, and specifically, may be different or the same in terms of the transition temperature.

### Mode for Disclosure

Hereinafter, the present disclosure will be described in detail with reference to examples. However, it should be noted that the examples according to the present disclosure may be modified into various other forms, and the scope of the present disclosure is not construed as being limited to the examples to be described below. The examples of the present specification are provided to more completely explain the present disclosure to those of ordinary skill in the art.

### Preparation Example 1

In the present disclosure, 100 mg of La (Fe, Si)₁₃—H powder (product name CALORIVAC H) (available from Vacuumschmeltze Company, Germany) was prepared and used.

### Example 1

About 3.75 g of the same powder as in Preparation Example 1 was filled inside a copper tube (inner diameter 6 mm, outer diameter 8 mm, length 50 mm), the opposite ends were sealed, and the diameter of the tube was reduced to about 2.5 mm through a groove rolling process. After that, it was processed into a tape with a thickness of 1 mm and a width of 3.5 mm through a flat rolling process.

Then, the spacers were formed through a pressing process by means of a punch on the surface of the tape and the tape was wound to manufacture a coil-shaped structure, and for analysis, a portion of the tape was cut off to prepare a specimen of a member for magnetic refrigeration filled with 26 mg of La (Fe, Si)₁₃—H powder.

### Example 2

About 3.75 g of the same powder as in Preparation Example 1 was filled inside a copper tube (inner diameter 6 mm, outer diameter 8 mm, length 50 mm), the opposite ends were sealed, and the diameter of the tube was reduced to about 2.5 mm through a groove rolling process. After that, it was processed into a tape with a thickness of 0.1 mm (100 μm) and a width of 4.5 mm through a flat rolling process.

Then, the spacers were formed through a pressing process by means of a punch on the surface of the tape and the tape was wound to manufacture a coil-shaped structure, and for analysis, a portion of the tape was cut off to prepare a specimen of a member for magnetic refrigeration filled with 4 mg of La (Fe, Si)₁₃—H powder.

### Example 3

About 3.75 g of the same powder as in Preparation Example 1 was filled inside a copper tube (inner diameter 6 mm, outer diameter 8 mm, length 50 mm), the opposite ends were sealed, and the diameter of the tube was reduced to about 2.5 mm through a groove rolling process. After that, it was processed into a tape with a thickness of 0.05 mm (50 μm) and a width of 5 mm through a flat rolling process.

Then, the spacers were formed through a pressing process by means of a punch on the surface of the tape and the tape was wound to manufacture a coil-shaped structure, and for analysis, a portion of the tape was cut off to prepare a specimen of a member for magnetic refrigeration filled with 2 mg of La (Fe, Si)₁₃—H powder.

### Experimental Example 1: Measurement and Analysis of M-T Curve

For the specimens of the members for magnetic refrigeration of Examples 1 to 3, the temperature was lowered to 260 K and an external magnetic field of 500 Oe was applied in the length direction of the specimens. As the temperature was increased to 340 K (Example 1) or 360 K (Examples 2 and 3) while applying a magnetic field, the magnetic moment (emu) of the sample was measured, and the magnetization (emu/g) was calculated by dividing the measured magnetic moment by the weight of the sample, and a magnetization curve according to the temperature (magnetization-temperature (M-T)) was plotted.

Additionally, for 33 mg of La (Fe, Si)₁₃—H powder as in Preparation Example 1, the temperature was lowered to 280 K and an external magnetic field of 500 Oe was applied in the length direction of the sample. As the temperature was increased to 320 K while applying a magnetic field, the magnetic moment (emu) of the sample was measured, and the magnetization (emu/g) was calculated by dividing the measured magnetic moment by the weight of the sample, and a magnetization curve as a function of the temperature (magnetization-temperature (M-T)) was plotted.

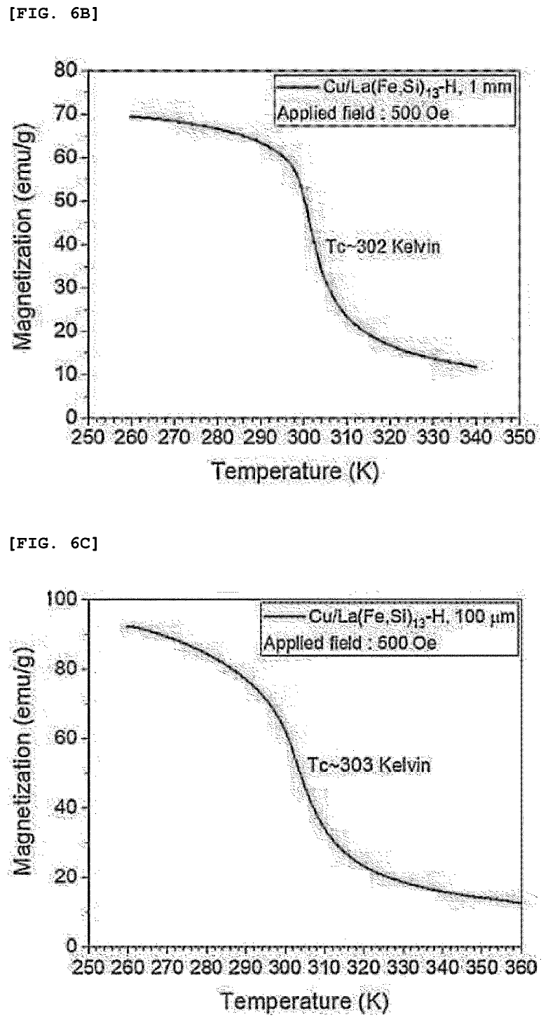

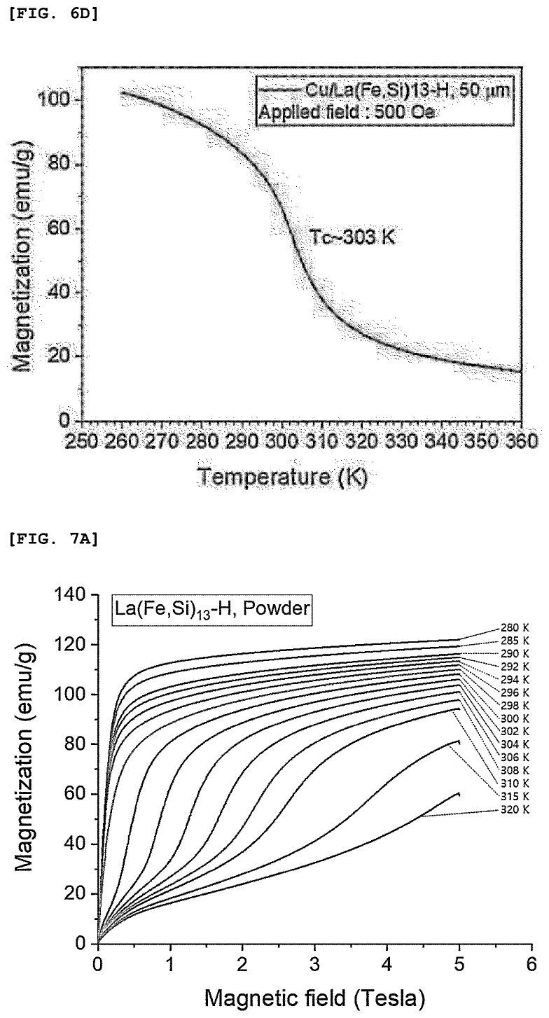

FIGS. 6A to 6D show the M-T curves of the La (Fe, Si)₁₃—H powder of Preparation Example 1 (FIG. 6A), the member for magnetic refrigeration of Example 1 (FIG. 6B), and the member for magnetic refrigeration of Example 2 (FIG. 6C) and the member for magnetic refrigeration of Example 3 (FIG. 6D).

Referring to FIGS. 6A to 6D, it can be seen that the powder of Preparation Example 1 has a transition temperature of about 300 K, and the members of Examples 1 to 3 have a similar transition temperature of 302 K to 303 K. This demonstrates that the transition temperature does not change significantly as the magnetic refrigeration material itself is the same. However, it can be seen that in the case of the La (Fe, Si)₁₃—H powder of Preparation Example 1, the magnetization value changes rapidly with respect to temperature and exhibits discontinuous first-order phase transition characteristics, while in the case of the members of Examples 1 to 3, the transition width increases exhibiting continuous second-order phase transition characteristics as a more gradual graph shape.

This is considered as a phenomenon that occurs because the magnetic refrigeration material powders filled in the inside of the members of Examples 1 to 3 become smaller than the initial powder sizes through external pressure and contact between internal powders by the groove rolling and flat rolling processes during the manufacturing process of the members of Examples 1 to 3. In particular, it is believed that this reflects the brittle nature of the powders used, which results in easy breaking off of the grain boundary portions and the reduction to the level of a single crystal size. Changes in crystallinity and hydrogen content of the powders seem to require more rigorous research in the future.

### Experimental Example 2: Measurement and Analysis of M-H Curve

For the La (Fe, Si)₁₃—H powder of Preparation Example 1 and the specimens of the members for magnetic refrigeration of Examples 1 to 3, the magnetic moment of each sample was measured while changing the magnetic field from 0 to 5 T and maintaining the temperature at 280K. Then, the same measurement was repeated by changing the temperature to 285 K, 290 K, 292 K, 294 K, 296 K, 298 K, 300 K, 302 K, 304 K, 306 K, 308 K, 310 K, 315 K, and 320 K.

In addition, for the members for magnetic refrigeration of Examples 2 and 3, the same measurement was further repeated by changing the temperature to 325 K, 330 K, 335 K, 340 K, 345 K, 350 K, 355 K, and 360 K.

The magnetization (emu/g) was calculated by dividing the measured magnetic moment by the weight of the sample, and a magnetization curve as a function of the magnetic field (Magnetization-Applied Field (M-H)) was plotted.

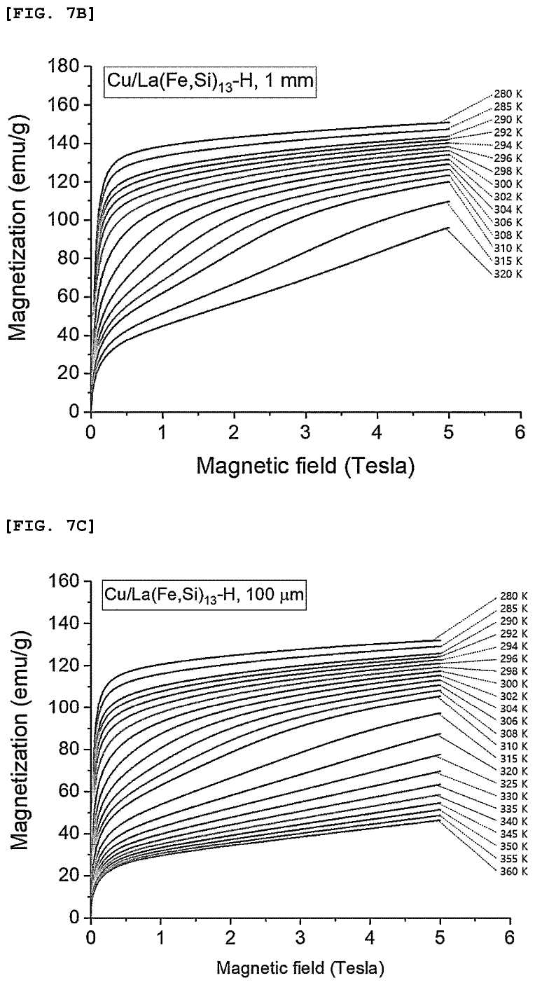

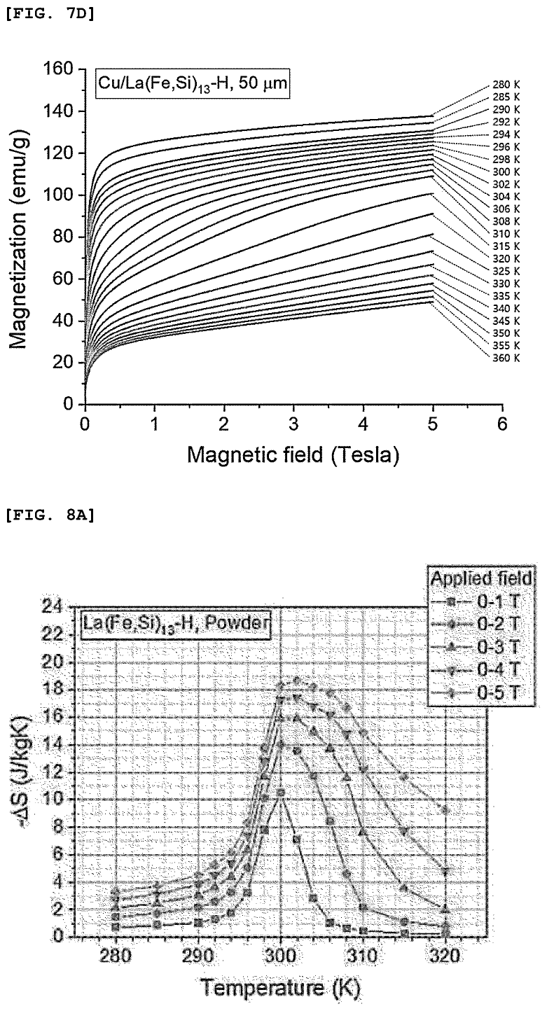

FIGS. 7A to 7D show the M-H curves of the La (Fe, Si)₁₃—H powder of Preparation Example 1 (FIG. 7A), the member for magnetic refrigeration of Example 1 (FIG. 7B), and the member for magnetic refrigeration of Example 2 (FIG. 7C) and the member for magnetic refrigeration of Example 3 (FIG. 7D).

Referring to FIGS. 7A to 7D, it can be seen that the powder of Preparation Example 1 has first-order phase transition characteristics, showing the characteristics of a ferromagnetic substance in which magnetization increases sharply and then becomes gradual as the magnetic field increases below the transition temperature. Meanwhile, at temperatures above the transition temperature, an S-shaped curve appears, indicating the existence of a metamagnetic transition from paramagnetism back to ferromagnetism. These transition characteristics contribute to the improvement of magnetocaloric characteristics, and cause the asymmetric curve with respect to the transition temperature in the ΔS-T graph described later.

Additionally, in the case of Examples 1 to 3, the first-order phase transition characteristics of the powder analyzed previously are reduced, and M-H characteristics close to the second-order phase transition characteristics are shown.

### Experimental Example 3: Illustration and Analysis of ΔS-T Graph

Based on the M-H curves of FIGS. 7A to 7D, a graph of entropy change as a function of temperature is shown using Maxwell's equation.

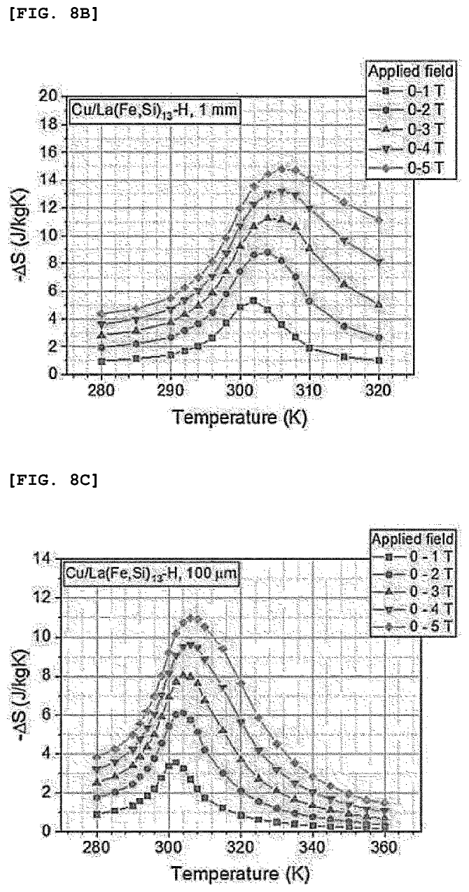

FIGS. 8A to 8D show the ΔS-T graphs of the La (Fe, Si)₁₃—H powder of Preparation Example 1 (FIG. 8A), the member for magnetic refrigeration of Example 1 (FIG. 8B), and the member for magnetic refrigeration of Example 2 (FIG. 8C) and the member for magnetic refrigeration of Example 3 (FIG. 8D).

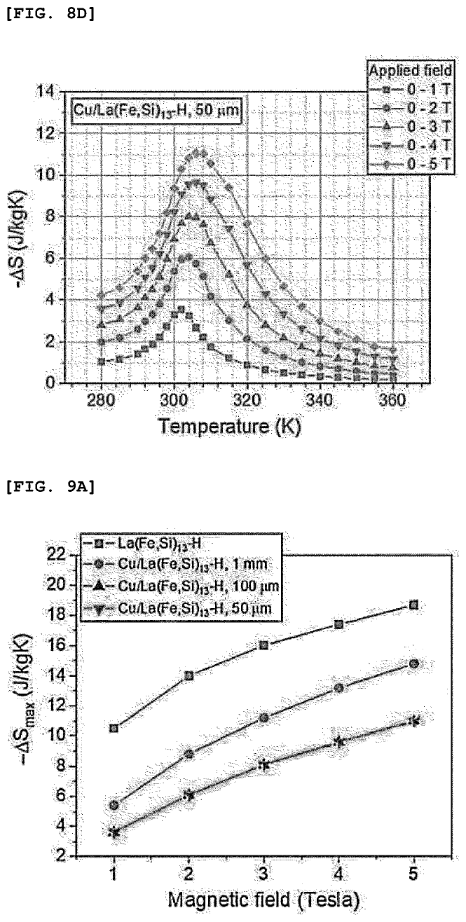

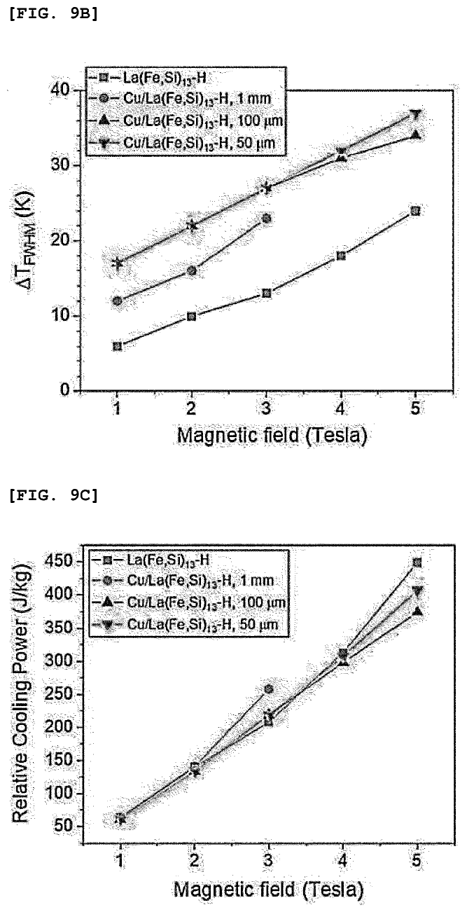

Additionally, based on the ΔS-T graphs of FIGS. 8A to 8D, FIGS. 9A to 9C show, with respect to the magnetic field ranging from 1 to 5T, graphs of the maximum value of the absolute value of the entropy change (|ΔS|) of the La (Fe, Si)₁₃—H powder of Preparation Example 1 and the members for magnetic refrigeration of Examples 1 to 3 (FIG. 9A), ΔT corresponding to FWHM (FIG. 9B), and the relative cooling efficiency calculated by multiplying them (FIG. 9C).

Referring to FIG. 9A, it can be seen that the maximum value of the absolute value of entropy change (|ΔS|) for the La (Fe, Si) 13-H powder of Preparation Example 1 is about 1.3 to 1.9 times higher than that of the member of Example 1, is about 1.7 to 2.9 times higher than that of the member of Example 2, and the member of Example 3 exhibits a value similar to that of the member of Example 2.

Meanwhile, referring to FIG. 9B, it can be seen that the full width at half maximum (FWHM), which is the temperature width at the points corresponding to half the absolute value (|ΔS|) in the ΔS-T graph, in the case of Example 1 is about 1.6 to 2 times higher than in the case of Preparation Example 1 in the range of ˜3 T, and the full width at half maximum at 4 T and 5 T could not be calculated because it went beyond the measurement temperature range. Additionally, it can be seen that the full width at half maximum in the case of Example 2 is 1.4 to 2.8 times higher than that in the case of Preparation Example 1, and is larger than that in the case of Example 1. And, it could be seen that in the case of Example 3, the full width at half maximum was similar to that of Example 2 up to 3 T, but increased slightly at 4 T and 5 T.

Additionally, referring to FIG. 9C, it can be seen that the powder of Preparation Example 1 and the cores of Examples 1 to 3 have a similar level of cooling efficiency in terms of relative cooling efficiency (RCP).

The above results may be considered as an effect resulting from that, when manufacturing a member for magnetic refrigeration according to an embodiment of the present disclosure, the magnetic refrigeration material powder is filled in the inside of the metal sheath through the PIT processing process and subjected to an external force such as external pressure, contact between powders or the like, so that, due to the influence of powder crystallinity, size effect or the like, the maximum value of entropy change decreases whereas the full width at half maximum increases.

While the present disclosure has been described by limited embodiments until now, the present disclosure is not limited by them, and various modifications can be made by those skilled in the art to which the present disclosure pertains without departing from the equivalent scope of the technical idea of the present disclosure and the claims to be provided below.

1. A member for magnetic refrigeration comprising:
a tape for magnetic refrigeration having a heat dissipation sheath, and a magnetic refrigeration material charged inside the heat dissipation sheath,
wherein a spacer is provided on the surface of the tape for magnetic refrigeration, and
wherein the tape for magnetic refrigeration has a concentric multi-layer structure.

2. The member for magnetic refrigeration of claim 1, wherein the concentric multi-layer structure has a concentric circle shape, a concentric ellipse shape, a concentric polygon shape, or a spiral shape in the cross section of the member for magnetic refrigeration.

3. The member for magnetic refrigeration of claim 1, wherein the heat dissipation sheath includes one or more kinds selected from the group consisting of metal, polymer, and high thermal conductive filler.

4. The member for magnetic refrigeration of claim 3, wherein the metal includes one or more kinds selected from the group consisting of Cu, Cu-based alloy, Ti, Ti-based alloy, Ni, Ni-based alloy, Ag, Fe, Nb, stainless steel, Gd, and Gd-based alloy.

5. The member for magnetic refrigeration of claim 3, wherein the high thermal conductive filler includes one or more kinds selected from the group consisting of aluminum nitride, boron nitride, magnesia, alumina, graphite, graphene, silicon carbide, diamond, aluminum, gold, copper, lead, stainless steel, and silver.

6. The member for magnetic refrigeration of claim 3, wherein the polymer includes one or more kinds selected from the group consisting of epoxy resin, polypropylene, high-density polyethylene, polyvinyl alcohol, silicone elastomer, polyimide, polystyrene, and polyvinylidene fluoride.

7. The member for magnetic refrigeration of claim 1, wherein the tape for magnetic refrigeration has a thickness of 0.01 mm to 1 mm.

8. The member for magnetic refrigeration of claim 1, wherein the magnetic refrigeration material includes one or more kinds selected from the group consisting of a Gd-based compound, a La(Fe,Si)₁₃-based compound, a La(Fe,Si)₁₃H-based compound, a La(Fe, Al)₁₃-based compound, a (Mn,Fe)₂(P,Si)-based compound, a Mn-based Heusler alloy, a Ln-based magnesite, and a FeRh-based compound.

9. The member for magnetic refrigeration of claim 1, wherein there are a plurality of the tapes for magnetic refrigeration, each of which is charged with the magnetic refrigeration material having a different transition temperature (T_{c}) along more than one section in the axial direction of the member for magnetic refrigeration.

10. The member for magnetic refrigeration of claim 1, wherein the tape for magnetic refrigeration is charged with the magnetic refrigeration material whose transition temperature (T_{c}) continuously varies in the axial direction of the member for magnetic refrigeration.

11. The member for magnetic refrigeration of claim 1, wherein the magnetic refrigeration material is included in the tape for magnetic refrigeration in a single-core structure or multi-core structure.

12. The member for magnetic refrigeration of claim 11, wherein when the magnetic refrigeration material is included in the tape for magnetic refrigeration in a multi-core structure, and
wherein the magnetic refrigeration material of each core is independently different from or identical to each other.

13. The member for magnetic refrigeration of claim 1, wherein the spacer has a height of 0.01 mm to 1 mm.

14. The member for magnetic refrigeration of claim 1, wherein there are a plurality of the spacers provided on part or all of the surface of the tape for magnetic refrigeration.

15. A bed for an active magnetocaloric regenerator (AMR) including a member for magnetic refrigeration of claim 1.

16. The bed for an active magnetocaloric regenerator of claim 15, wherein the AMR bed includes a plurality of the members for magnetic refrigeration.
